(19) United States
(12) Patent Application Publication
(10) Pub. No.: US 2018/0289188 A1
(43) Pub. Date: Oct. 11, 2018

(54) VOLUMETER FOR FOOD PRODUCTS

(71) Applicant: NESTEC S.A., Vevey (CH)

(72) Inventors: Madison HOCKER, Holt, MI (US); Wayne GUERNE, Bailey, MI (US); Cortney Shizuko LEONARD, Grand Rapids, MI (US)

(21) Appl. No.: 15/944,086

(22) Filed: Apr. 3, 2018

Related U.S. Application Data
(60) Provisional application No. 62/481,931, filed on Apr. 5, 2017.

(51) Int. Cl. A47G 19/34

(52) U.S. Cl. CPC A47G 19/34; G01F 11/40

(57) ABSTRACT

A volumeter for food products having a canister supported by a support structure, a hopper connected to the support structure, and a leveler plate slidably supported by the support structure and slidable between an open position and a closed position for controlling the flow of the food product from the hopper and into the canister and for leveling an upper end of the food product.

### CROSS REFERENCE TO RELATED APPLICATION

This application claims priority to U.S. Provisional Application Ser. No. 62/481,931, filed Apr. 5, 2017, the entire contents of which being hereby expressly incorporated herein by reference.

### BACKGROUND

Apparent or bulk density is a property of powders, granules, and other “divided” solids. Apparent density is determined by dividing the mass of a divided solid by the total volume of the solid. For example, a divided solid may be placed into a container of a known volume. The volume measured will include the intermediate and hollow spaces in the container. Therefore, the apparent density depends on the form of the particles, the composition of the substance, the spatial arrangement of the particles, and the method of storage and handling. For example, when a divided solid is poured into a container, rounded, compact particles will be closer together to one another than edged, splintery particles. As such, the bulk density of a product can be difficult to measure with good reproducibility.

Furthermore, the density of free flowing divided solids depends strongly on external mechanical forces such as the procedure and the device used for measuring the apparent density. Because apparent density can change depending on how the divided solid is handled, various devices for measuring apparent density have been developed. For example, such devices may measure the “poured” density of a powder, which involves pouring the powder into a cylinder to freely settle, or the “tapped” density, which involves compacting the powder, usually after vibrating the powder's container. Due to the friability and caking properties of powders, the varying geometry of particles, and the unavoidable compaction resulting from pouring a powder into a container, the apparent “poured” density will generally differ from that of a product in its original container or package. Devices for measuring the apparent “poured” density commonly include volumeters, which generally consist of a top funnel or hopper spaced apart from and mounted over a receiving cup or canister.

Although volumeters for measuring the apparent density of powders are well known, such devices are undesirable for other solids, such as many types of food products, including, but not limited to, puffy, crispy or crunchy, cereal or starchy “finger foods”, puffed food product, popped food product, extruded food products, and direct-expanded extruded food products. Direct-expanded extruded food products are typically puffy, crispy or crunchy, cereal or starchy “finger foods” that come in a variety of shapes and sizes are formed from raw materials, such as flour, corn, wheat, rice, oats, and proteins, and are processed in an extruder resulting in a continuous mass that is cut into pieces of uniform size, and subsequently dried, flavored, and stored. The apparent density of direct-expanded extruded food products may vary depending on whether the product is expanded due to changes in atmospheric pressure as it exits the extruder or if it is expanded later in processing through frying, heating in a microwave, and the like.

The procedures associated with traditional volumeters require a user to allow an excess of divided solid to flow through the funnel and into the receiving cup until the solid overflows, before scraping the excess powder from the top of the cup with a spatula to level the upper end of the divided solid. Current volumeters are therefore not compatible with many types of food products, because many types of food products cannot be easily scraped off the top of a canister with a spatula. Further, such known devices and procedures create an undesirable mess in a food processing environment because the food product is allowed to overflow the canister.

To this end, a need exists for a volumeter that includes a self-leveling feature and that enables consistent, reproducible measurements of food products while keeping the food product contained and the measuring area free of loose food product. It is to such a volumeter that the inventive concepts disclosed herein are directed.

### BRIEF DESCRIPTION OF THE DRAWINGS

FIG. 1 is a perspective view of a volumeter constructed in accordance with the inventive concepts disclosed herein shown in an open position.

FIG. 2 is a perspective view of the volumeter of FIG. 1 shown in a closed position.

FIG. 3 is a sectional view taken along line 3-3 of FIG. 1.

FIG. 4 is a sectional view taken along line 4-4 of FIG. 2.

FIG. 5 is a sectional view of the volumeter shown in the closed position with a food product loaded in a hopper.

FIG. 6 is a sectional view of the volumeter shown in the open position with the food having flowed into the canister.

FIG. 7 is a sectional view of the volumeter shown in a closed positioned with the food product leveled off in the canister.

### DETAILED DESCRIPTION OF EXEMPLARY EMBODIMENTS

In the following detailed description of embodiments of the inventive concepts, numerous specific details are set forth in order to provide a more thorough understanding of the inventive concepts. However, it will be apparent to one of ordinary skill in the art that the inventive concepts disclosed and claimed herein may be practiced without these specific details. In other instances, well-known features have not been described in detail to avoid unnecessarily complicating the instant disclosure.

As used herein, the terms “comprises,” “comprising,” “includes,” “including,” “has,” “having” or any other variation thereof, are intended to cover a non-exclusive inclusion. For example, a process, method, article, or apparatus that comprises a list of elements or steps is not necessarily limited to only those elements or steps and may include other elements, steps, or features not expressly listed or inherently present therein.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B is true (or present).

In addition, use of the “a” or “an” are employed to describe elements and components of the embodiments herein. This is done merely for convenience and to give a general sense of the inventive concepts. This description should be read to include one or at least one and the singular also includes the plural unless it is obvious that it is meant otherwise.

Throughout this disclosure and the claims, the terms “about,” “approximately,” and “substantially” are intended to signify that the item being qualified is not limited to the exact value specified, but includes some slight variations or deviations therefrom, caused by measuring error, manufacturing tolerances, stress exerted on various parts, wear and tear, or combinations thereof, for example.

The use of the term “at least one” will be understood to include one as well as any quantity more than one, including but not limited to each of, 2, 3, 4, 5, 10, 15, 20, 30, 40, 50, 100, and all integers there between. The term “at least one” may extend up to 100 or 1000 or more, depending on the term to which it is attached; in addition, the quantities of 100/1000 are not to be considered limiting, as higher limits may also produce satisfactory results. Singular terms shall include pluralities and plural terms shall include the singular unless indicated otherwise.

The term “or combinations thereof” as used herein refers to all permutations and/or combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily referring to the same embodiment, although the inventive concepts disclosed herein are intended to encompass all combinations and permutations including one or more of the features of the embodiments described herein.

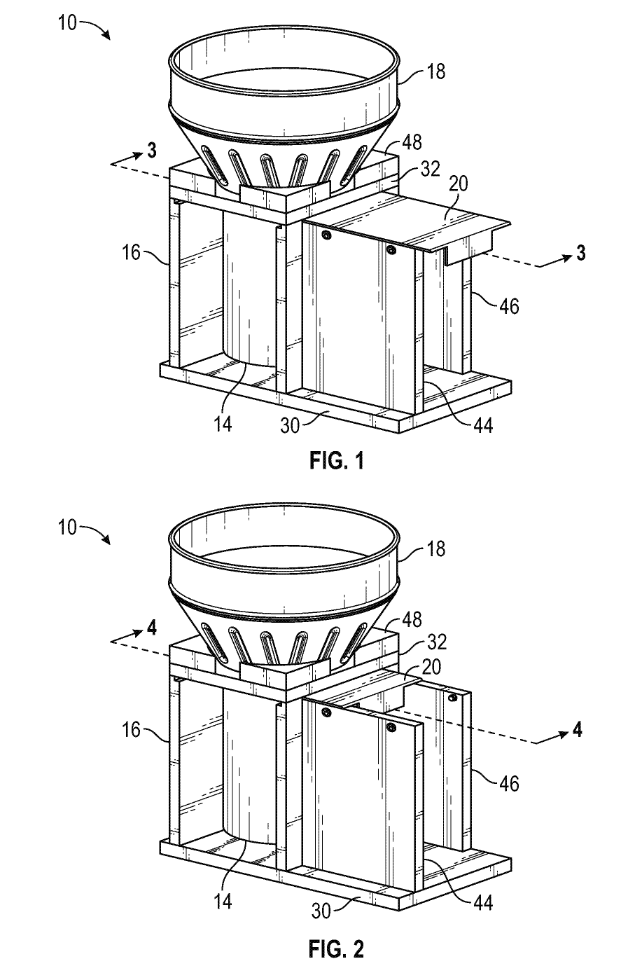

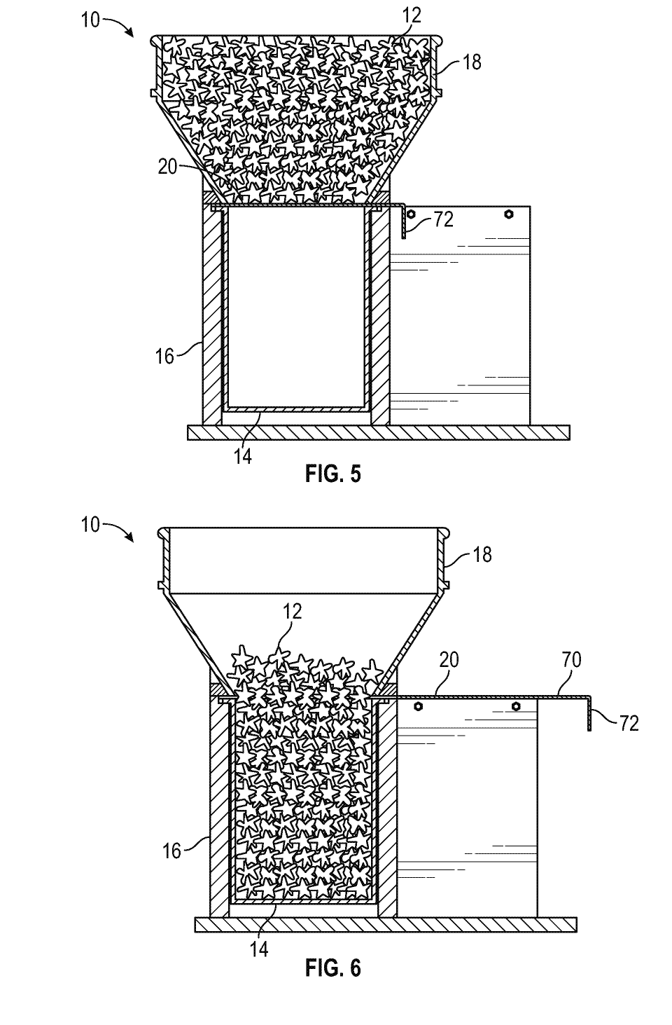

Referring now to FIGS. 1-7, a volumeter 10 for use in measuring the apparent density of a food product 12 (FIGS. 5-7) and constructed in accordance with the inventive concepts is illustrated. In one embodiment, the food product 12 may be a directed-expanded extruded food product, commonly referred to as a puffed snack or finger food. The food product 12 in FIGS. 5-7 is shown as having a star shape for illustration purposes only. It should be appreciated that the size and shape of the food product 12 may vary and may include, but is not limited to including, balls, curls, rings, sticks, pillows, honeycombs, or any other shape known in the art.

As shown in FIG. 1-7, the volumeter 10 includes a canister 14 supported by a support structure 16, a hopper 18 connected to the support structure 16, and a leveler plate 20 supported by the support structure 16 and slidable between an open position (shown in FIG. 1) and a closed position (shown in FIG. 2). As will be explained in further detail below, in preparation for measuring the apparent density of the food product 12, the food product 12 is loaded in the hopper 18 when the leveler plate 20 is in the closed position. Next, the leveler plate 20 is removed from the closed position to permit the food product 12 to pass from the hopper 18 and into the canister 14. Then, the leveler plate 20 is returned to the closed position to stop the flow of the food product 12 and level the upper end of the food product 12.

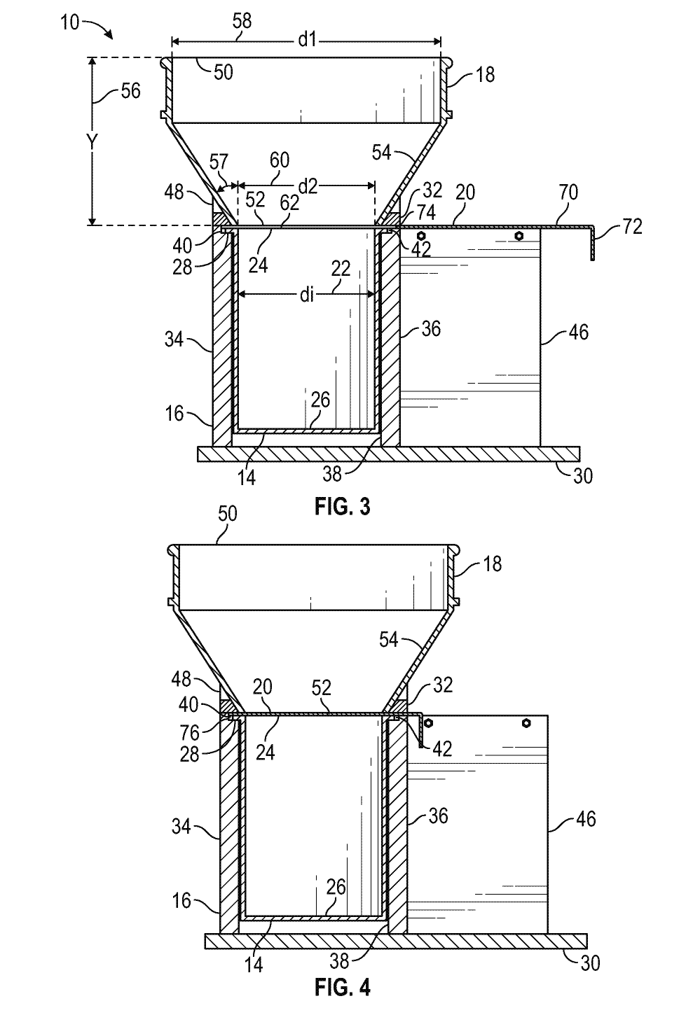

As best shown in FIGS. 3 and 4, the canister 14 has an inner diameter 22, a volume, a weight, an open upper end 24, a closed lower end 26, and a flange 28 extending outwardly from the open upper end 24. The canister 14 may be made of a variety of materials, including but not limited to plastic or metal, such as aluminum or stainless steel. The canister 14 may also be formed of a variety of sizes that can accommodate the size of a given food product. For example, the canister may be between 1.5 and 2.5 liters and may have an inner diameter between 4.5 and 5.5 inches. In one embodiment, the canister 14 has volume of 2.0 liters and an inner diameter of 5.0 inches.

The support structure 16 may include a lower platform 30, an upper platform 32, and a first wall 34 and a second wall 36 spaced apart in a parallel relationship and positioned between the lower platform 30 and the upper platform 32. The first and second walls 34 and 36 of the support structure 16 form a canister receiving space 38 for receiving the flange 28 of the canister 14. In one embodiment, the first and second walls 34 and 36 include a pair of opposing grooves 40/42 for receiving the flange of the canister 14. The grooves 40/42 may receive the flange by a variety of means known in the art. In one embodiment, the grooves 40/42 slidingly receive the flange 28 of the canister 14. In another embodiment, the support structure 16 supports the canister 14 in the canister receiving space 38 with the lower end 26 of the canister 14 suspended above the lower platform 30 or lower end of the support structure 16.

The support structure 16 may also include a third wall 44 and a fourth wall 46 (shown best in FIGS. 1 and 2) for supporting the leveler plate 20, discussed in more detail below. The support structure 16 may be sized and shaped to accommodate the width and volume of the canister 14 and may be constructed of a variety of materials including, but not limited to, plastic or metal.

The hopper 18 is connected to the support structure 16 in a way that the hopper 18 is supported above the canister 14 receiving space so that the hopper 18 is axially aligned with the canister 14 when the canister 14 is positioned in the canister receiving space 38. The hopper 18 may be further supported by a plurality of support members 48 (best shown in FIGS. 1 and 2) connected to the top of the support structure 16 to ensure stability of the hopper 18. The upper platform 32 of the support structure 16 includes an opening 62 adjacent to the lower end 52 of the hopper 18. The opening 62 allows the food product 12 to flow from the hopper 18 through the opening 62 and into the canister 14.

The hopper 18 includes an upper end 50, a lower end 52, a conical portion 54, and a longitudinal axis 56. The upper end 50 has a first diameter 58 and the lower end 52 has a second diameter 60. The second diameter 60 is less than the first diameter 58. In one embodiment, the second diameter 60 is substantially equal to the inner diameter 22 of the canister 14. The conical portion 54 of the hopper is angled relative to the longitudinal axis 56 and an angle 57. The hopper 18 may be formed of a variety of sizes. For example, the hopper 18 may have a volume between 2.5 and 3.5 liters; the second diameter 60 may be between 4.5 and 5.5 inches; and the angle 57 may range from about 30° to 50°. In one embodiment, the hopper 18 has a volume of at least 3.0 liters, the second diameter 60 is about 5.0 inches, and the angle 57 is about 30°. The hopper 18 may be formed from a variety of materials, including but not limited to plastic and metal, such as aluminum or stainless steel.

As best shown in FIGS. 3 and 4, the leveler plate 20 is slidingly supported by the support structure 16. The leveler plate 20 includes a planar portion 70 and a handle portion 72. The leveler plate 20 is slidable between an open position (shown in FIG. 3), wherein the leveler plate 20 is removed from between the lower end 52 of the hopper 18 and the open upper end 24 of the canister 14, and a closed position (shown in FIG. 4), wherein the leveler plate 20 is positioned between the lower end 52 of the hopper 18 and the open upper end 24 of the canister 14 in a way that the leveler plate 20 stops the flow of food product 12 from the hopper 18. In the closed position, the leveler is positioned across the open upper end 24 of the canister 14 and is in contact with the flange 28 of the canister 14 and with the bottom surface of the upper platform 32 of the support structure 16.

Returning to FIGS. 1-2, the third wall 44 and the fourth wall 46 are spaced apart in a parallel relationship from one another to support the leveler plate 20. The third and fourth wall 44 and 46 are supported by the lower platform 30 of the support structure 16 and may be in a perpendicular relationship with the first and second walls 34 and 36. As shown in FIG. 3, the second wall 36 of the support structure 16 may include a slot 74 for receiving the planar portion 70 of the leveler plate 20. As shown in FIG. 4, the first wall 34 may include a stop portion 76 against which the planar portion 70 of the leveler plate 20 rests when it is in the closed position. When sliding between the open position and the closed position, the planar portion 70 of the leveler plate 20 may slide over the second and third walls 44 and 46 in a way that the handle portion 72 of the leveler plate 20 passes between the third and fourth walls 44 and 46 as the planar portion 70 slides between the lower end 52 of the hopper 18 and the upper end 24 of the canister 14. In one embodiment, the leveler plate 20 moves in a direction perpendicular to the grooves 40/42 of the support structure 16.

Referring now to FIGS. 4-7, a method of measuring the apparent density of a food product, such as the food product 12, is described. First, the canister 14 is obtained. Then, the canister 14 is supported below the hopper 18 connected to the support structure 16 forming the canister receiving space 38. The support canister 14 may be supported by a variety of mechanisms known in the art. In one embodiment, the canister 14 is supported by the grooves 40/42 of the support structure 16. By way of example only, the canister 14 may be supported by sliding the flange 28 of the canister 14 into the grooves 40/42. In one embodiment, the support structure supports 16 supports the canister 14 in a way that the lower end 26 of the canister 14 is suspended above the lower platform 30 of the support structure 16.

As shown in FIG. 4, once the canister 14 is supported by the support structure 16, the lower end 52 of the hopper 18 is closed with the leveler plate 20 positioned between the lower end 52 of the hopper 18 and the open upper end 24 of the canister 14. The user may slide the leveler plate 20 into the closed position by pushing the handle portion 72 of the leveler plate 20 towards the second wall 36 so that the planar portion 70 may slide through the slot 74 in the second wall 36 until the planar portion 70 comes to rest against the stop portion 76 of the first wall 34. Closing the lower end of the hopper 18 also closes the opening 62 on the upper platform 32. In the closed position, the leveler plate 20 contacts the flange 28 of the canister 14 and bottom surface of the upper platform 32.

As shown in FIG. 5, the hopper 18 is then loaded with an amount of the food product 12. The amount of the food product 12 loaded in the hopper 18 is greater than the volume of the canister 14. Because the leveler plate 20 is in the closed position, the food product 12 is prevented from passing from the hopper 18 and into the canister 14.

Next, as shown in FIG. 6, the leveler plate 20 is removed from between the lower end 52 of the hopper 18 and the open upper end 24 of the canister 14 to permit the food product 12 to pass from the hopper 18 and into the canister 14. The leveler plate 20 is removed by pulling the handle portion 72 of the plate 20 away from the second wall 36 and sliding the plate through the slot 74 of the second wall 36. The leveler plate 20 remains in the open position until the canister 14 is completely filled with the food product 12. The angle of the hopper 18 ensures proper mass flow so that the food product 12 freely flows from the hopper 18 without getting stuck in the hopper 18.

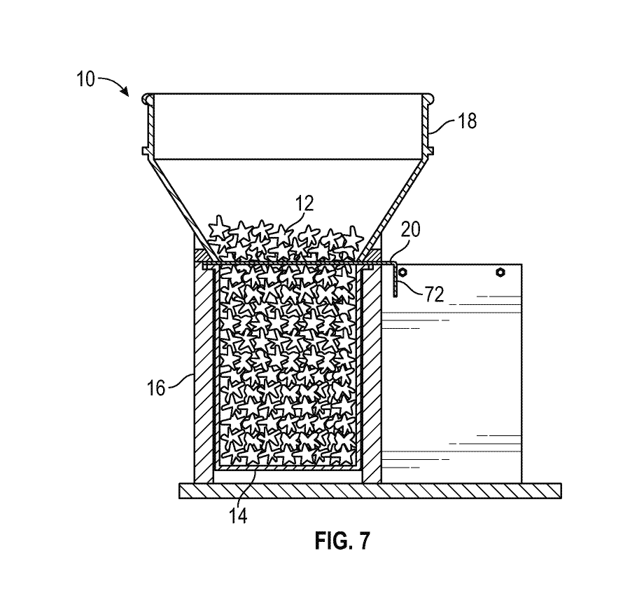

As shown in FIG. 7, the leveler plate 20 is then positioned between the lower end of the hopper 18 and the upper end of the canister 14 in way that that the leveler plate 20 stops the flow of the direct-expanded food product 12 from the hopper 18. Further, the leveler plate 20 is positioned across the open upper end 24 of the canister 14 and in contact with the flange 28 so as to level an upper end of the direct-expanded food product 12. Leveling the food product 12 with the plate 20 may reduce human error thereby providing more consistent and accurate measurements. Also, due to the proper mass flow of the product from the hopper 18 and into the canister 14, the canister 14 is filled with the food product 12 instead of being packed with the food product 12, which aids in consistent and accurate measurements. Furthermore, due to the orientation of the hopper 18, the leveler plate 20, and the canister 14, the food product 12 does not spill from the volumeter 10 such that messes may be avoided.

Once the leveler plate 20 is in the closed position and the canister 14 is full of the food product 12, the canister 14 is removed from the support structure 16 by, for example, sliding the flange 28 out of the grooves 40/42 in the support structure 16. The canister 14 containing the direct-expanded food product 12 is then weighed so that the apparent density may be calculated based on the known volume of the canister 14. The volumeter 10 may be preferably used in a controlled environment with limited humidity.

From the above description, it is clear that the inventive concepts disclosed and claimed herein are well adapted to carry out the objects and to attain the advantages mentioned herein, as well as those inherent in the invention. While exemplary embodiments of the inventive concepts have been described for purposes of this disclosure, it will be understood that numerous changes may be made which will readily suggest themselves to those skilled in the art and which are accomplished within the spirit of the inventive concepts disclosed and claimed herein.

1. A volumeter for food products, comprising:
a canister having an inner diameter, a volume, an open upper end, a closed lower end, and a flange extending outwardly from the open upper end;
a support structure forming a canister receiving space for receiving the flange of the canister in a way that supports the canister in the canister receiving space;
a hopper with an upper end, a lower end, and a conical portion, the upper end having a first diameter and the lower end having a second diameter less than the first diameter, the hopper connected to the support structure in a way that the hopper is supported above the canister receiving space so that the hopper is axially aligned with canister when the canister is positioned in the canister receiving space; and
a leveler plate slidably supported by the support structure, the leveler plate slidable between an open position wherein the leveler plate is removed from between the lower end of the hopper and the open upper end of the canister, and a closed position wherein the leveler plate is positioned between the lower end of the hopper and the open upper end of the canister in a way that the leveler plate stops the flow of food product from the hopper and is positioned across the open upper end of the canister in contact with the flange.

2. The volumeter of claim 1, wherein the support structure has a pair of opposing grooves for receiving the flange of the canister.

3. The volumeter of claim 1, wherein the support structure is formed to support the canister with the lower end of the canister suspended above a lower end of the support structure.

4. The volumeter of claim 1, wherein the second diameter of the hopper is substantially equal to the inner diameter of the canister.

5. The volumeter of claim 1, wherein the hopper has a longitudinal axis, and wherein the conical portion of the hopper is angled relative to a longitudinal axis at an angle in the range of from about 30° to about 50°.

6. The volumeter of claim 1, wherein the leveler plate moves in a direction perpendicular to the grooves of the support structure.

7. The volumeter of claim 1, wherein the food product is positioned in the hopper; and wherein the leveler plate slidable between an open position wherein the leveler plate is removed from between the lower end of the hopper and the open upper end of the canister to permit the food product to pass from the hopper and into the canister, and a closed position wherein the leveler plate is positioned between the lower end of the hopper and the open upper end of the canister in a way that the leveler plate stops the flow of the food product from the hopper and is positioned across the open upper end of the canister in contact with the flange so as to level an upper end of the food product.

8. The volumeter of claim 1, wherein the food product is at least one of: a puffy food product, a crispy food product, a crunchy food product, extruded food product, direct-expanded extruded food products, a puffed food product, a popped food product, or combinations thereof.

9. The volumeter of claim 1, wherein the food product is a direct-expanded extruded food product.

10. The volumeter of claim 9, wherein the direct-expanded extruded food product is selected from a group consisting of corn, wheat, rice, potato, tapioca, oats, and protein.

11. A method of measuring the bulk density of a food product using a volumeter, the method comprising:
obtaining a canister having an inner diameter, a volume, a weight, an open upper end, a closed lower end, and a flange extending outwardly from the open upper end;
supporting the canister below a hopper with a support structure forming a canister receiving space, the hopper having an upper end, a lower end, and a conical portion, the upper end having a first diameter and the lower end having a second diameter less than the first diameter;
closing the lower end of the hopper with a leveler plate positioned between the lower end of the hopper and the open upper end of the canister;
loading the hopper with an amount of the food product greater than the volume of the canister;
removing the leveler plate from between the lower end of the hopper and the open upper end of the canister to permit the food product to pass from the hopper and into the canister;
positioning the leveler plate between the lower end of the hopper and the open upper end of the canister in a way that the leveler plate stops the flow of the direct-expanded food product from the hopper and is positioned across the open upper end of the canister in contact with the flange so as to level an upper end of the food product;
removing the canister with the food product from the support structure; and
weighing the canister with the food product.

12. The method of claim 11, wherein the second diameter of the hopper is substantially equal to the inner diameter of the canister.

13. The method of claim 11, wherein the support structure further includes a pair of opposing grooves for receiving the flange of the canister.

14. The method of claim 12, wherein the step of supporting the canister further comprises positioning the flange of the canister into the grooves of the support structure so that the lower end of the canister is suspended above a lower end of the support structure.

15. The method of claim 13, wherein the pair of opposing grooves slidingly receive the flange of the canister.

16. The method of claim 11, wherein the food product is at least one of: a puffy food product, a crispy food product, a crunchy food product, extruded food product, direct-expanded extruded food products, a puffed food product, a popped food product, or combinations thereof.

17. The method of claim 11, wherein the food product is a direct-expanded extruded food product.

18. The method of claim 17, wherein the direct-expanded extruded food product is selected from a group consisting of corn, wheat, rice, potato, tapioca, oats, and protein.

19. The method of claim 11, wherein the volumeter is selected from the group consisting of those claimed in any one of claim 1 to claim 10.
